(19) United States
(12) Patent Application Publication
(10) Pub. No.: US 2014/0065274 A1
(43) Pub. Date: Mar. 6, 2014

(54) SYSTEMS AND METHODS FOR STORING AND TRANSPORTING PERISHABLE FOODS

(71) Applicant: Laurence D. Bell, Mountain View, CA (US)

(72) Inventor: Laurence D. Bell, Mountain View, CA (US)

(73) Assignee: Global Fresh Foods

(21) Appl. No.: 13/601,796

(22) Filed: Aug. 31, 2012

(51) Int. Cl. A23B 4/16

(52) U.S. Cl. 426/418

(57) ABSTRACT

Disclosed are methods for producing and maintaining a very low level of oxygen in a sealed container for maintaining a foodstuff. In one aspect, the method comprises (1) a first oxygen reduction step wherein the oxygen content in said container is reduced to no more than 20,000 ppm; (2) maintaining the foodstuff in the container such that the oxygen content in the foodstuff and the gaseous environment approaches equilibrium; and (3) a second oxygen reduction step wherein the oxygen content in said container is reduced to no more than 2000 ppm. Systems useful in the methods disclosed herein.

### TECHNICAL FIELD

This invention relates to systems and methods for producing and maintaining a very low oxygen level in a sealed container for storing and transporting perishable foodstuff.

### BACKGROUND

The storage-life of oxidatively-degradable foodstuffs such as fish, meat, and poultry is limited in the presence of a normal atmospheric environment. The presence of oxygen at levels found in a normal atmospheric environment leads to changes in odor, flavor, color, and texture resulting in an overall deterioration in quality of the foods either by chemical effect or by growth of aerobic spoilage microorganisms.

Modified atmosphere packaging (MAP) has been used to improve storage-life and safety of stored foods by inhibition of spoilage microorganisms and pathogens. MAP is the replacement of most of the normal atmospheric environment in a food storage pack with a single inert gas or a mixture of inert gases. The resulting gas in a MAP mixture is most often combinations of nitrogen (N₂) and carbon dioxide (CO₂) with a small amount of oxygen (O₂). In most cases, the bacteriostatic effect is obtained by a combination of decreased O₂ and increased CO₂ concentrations. Farber, J. M. 1991. Microbiological aspects of modified-atmosphere packaging technology: a review. J. Food Protect. 54:58-70.

U.S. Pat. No. 8,187,653 and US Patent Application Publication Nos. 2011/0151070 and 2011/0151084, and International Application WO2011/053676 provide methods and systems of preserving oxidatively-degradable foodstuffs in containers, such as totes, having an atmosphere that is low in O₂, and in some embodiments, high in CO₂. These methods and systems have demonstrated uniquely extended shelf life after removal from the “Controlled” atmosphere compared to conventional MAP and Vacuum packaging technologies. These publications are incorporated by reference in their entirety.

Notwithstanding the benefits imparted by these methods and systems, after purging, oxygen levels increase and rise to a level which is quite variable despite the fact that the purging process used similar protocols. Accordingly, there is needed an understanding of how such variability arises and how to resolve it.

### SUMMARY

This invention is directed, in part, to the discovery that oxygen present in a food product stored in a modified atmosphere will leach from the food over time and increase the oxygen content. The amount of oxygen leached depends upon a number of factors such as the amount of food in the package, the type of food, the level of oxygen releasing components in the food, equilibrium constants between the gas and food (solid phase) and the like. Without being limited to any theory, it is believed that some or all of these factors contribute to the variability in the amount of oxygen found in the modified atmosphere well after purging is complete.

This invention is further directed, in part, to the discovery that an initial purge of the food in a sealed container with an inert gas followed by an equilibrium period and then followed by a second purge with the same or different inert gas results in consistently low oxygen levels in the container over a prolonged period of time.

Accordingly, in one aspect, provided herein is a method for producing and maintaining a very low level of oxygen in a sealed container which comprises a foodstuff, said method comprising
a) a first oxygen reduction step wherein the oxygen content in said container is reduced to no more than 20,000 ppm;
b) maintaining the foodstuff in the container such that the oxygen content in the foodstuff and the gaseous environment of the container approaches equilibrium; and
c) a second oxygen reduction step wherein the oxygen content in said container is reduced to no more than 2000 ppm.

In another aspect, provided herein is a method for producing and maintaining a very low level of oxygen in a sealed container which comprises a foodstuff, said method comprising
a) replacing oxygen in said container by flushing said container with a low oxygen gas;
b) sealing said container in such a manner that the gaseous contents of said container are in communication with a fuel cell;
c) a first oxygen reduction step wherein the oxygen content in said container is reduced to no more than 20,000 ppm by contacting the gaseous contents of said container with the fuel cell and hydrogen under conditions wherein oxygen is converted to water;
d) maintaining the foodstuff in the container such that the oxygen content in the foodstuff and the gaseous environment approaches equilibrium;
e) a second oxygen reduction step wherein the oxygen content in said container is reduced to no more than 2000 ppm; and
f) optionally removing the fuel cell from gaseous communication with the container.

In some embodiments of the foregoing aspects, the oxygen content after the second oxygen reduction step is maintained in the sealed container for at least three days.

In some embodiments, the oxygen concentration is reduced in each step by a fuel cell, flush with a low-oxygen gas, or combination thereof. In some embodiments the low oxygen gas is an inert gas. In some embodiments, the inert gas is nitrogen, carbon dioxide, a combination thereof.

In some embodiments, the fuel cell is internal to the container. In some embodiments, the fuel cell is external to the container.

In some embodiments, the oxygen concentration in the atmosphere of the sealed container is reduced to no more than 5000 ppm after the first oxygen reduction step. In some embodiments, the oxygen concentration in the atmosphere of the sealed container is reduced to no more than 3000 ppm after the first oxygen reduction step.

In some embodiments, the foodstuff is incubated in the atmosphere produced after the first oxygen reduction step for at least 1 hour. In some embodiments, the foodstuff is incubated in the atmosphere produced in the first oxygen reduction step for at least 6 hours.

In some embodiments, the oxygen concentration in the atmosphere of the sealed container is reduced to no more than 1000 ppm after the second oxygen reduction step. In some embodiments, the oxygen concentration in the atmosphere of the sealed container is reduced to no more than 100 ppm after the second oxygen reduction step.

In some embodiments, the sealed container is a tote comprising a flexible, collapsible or expandable material. In some embodiments, the tote comprises a headspace. In some embodiments, the sealed container is rigid container.

In some embodiments the foodstuff is meat or fish.

In another aspect, provided herein are containers, systems and devices useful in the methods.

These and other aspects of the invention is further described in the text that follows.

### DETAILED DESCRIPTION

### Definitions

It is to be noted that as used herein and in the claims, the singular forms “a,” “an” and “the” include plural referents unless the context clearly dictates otherwise. Thus, for example, reference to “a fuel cell” includes one, two or more fuel cells, and so forth.

The term “comprising” is intended to mean that the articles and methods include the recited elements, but do not exclude others. “Consisting essentially of” when used to define articles and methods, shall mean excluding other elements of any essential significance to the intended use. “Consisting of” shall mean excluding more than trace amounts of other elements and substantial method steps.

The term “about” when used before a numerical designation, e.g., temperature, time, amount, and concentration, including range, indicates approximations which may vary by (+) or (−) 15%, 10%, 5% or 1%.

The term “freshness” refers to a state of a foodstuff that displays characteristics, such as a color, texture and smell, as if it is just produced.

The term “inert gas” refers to a gas that is non-toxic and does not react with the foodstuff. Examples of inert gas include nitrogen, carbon dioxide, argon, krypton, helium, nitric oxide, nitrous oxide, and xenon.

The term “sealed container” refers to a container whose interior is isolated from ambient atmosphere without uncontrolled introduction and/or emission of gas, except gas that may diffuse into and/or out of the container through its wall material. A sealed container may comprise inlets and/or outlets which, when opened, allow controlled introduction and/or emission of gas to or from the container. Thus, a container is considered sealed for the purpose of this invention, if the architecture of the container controls the gas content within the container. In one embodiment, the architecture employs only the gas inside the container without the introduction of any further exogenous gases. The sealed container also encompasses architecture where gas can be introduced or released under controlled conditions. In some situations, the architecture only permits additional gas intake. This is particularly important in situations where the foodstuff absorbs gas, such as carbon dioxide. The intake of additional gas allows controlled gas intake into the headspace of the container. In another embodiment, the architecture permits both releasing a portion of the gas outside the container and introducing a different gas into the container. Such a system permits a more rapid deoxygenating process. Regardless, the container is considered sealed as the gaseous contents in the container are controlled and are independent of the atmosphere. Simply put, a sealed container is a container designed to prevent ambient atmospheric gas from entering into the container except by diffusion through the container material (e.g., diffusion through a flexible plastic sheet). “Ambient atmosphere gas” or “ambient air” refers to gas in the general atmosphere typically comprising about 78% of nitrogen and about 21% of oxygen.

The term “deoxygenation of a foodstuff” or “deoxygenate of a foodstuff” refers to reduction of the oxygen contained in and around the foodstuff.

### Methods

In one aspect, provided herein is a method for producing and maintaining a very low level of oxygen in a sealed container which comprises a foodstuff, said method comprising
a) a first oxygen reduction step wherein the oxygen content in said container is reduced to no more than 20,000 ppm;
b) maintaining the foodstuff in the container such that the oxygen content in the foodstuff and the gaseous environment of the container approaches equilibrium; and
c) a second oxygen reduction step wherein the oxygen content in said container is reduced to no more than 2000 ppm.

In another aspect, provided herein is a method for producing and maintaining a very low level of oxygen in a sealed container which comprises a foodstuff, said method comprising
a) replacing oxygen in said container by flushing said container with a low oxygen gas;
b) sealing said container in such a manner that the gaseous contents of said container are in communication with a fuel cell;
c) a first oxygen reduction step wherein the oxygen content in said container is reduced to no more than 20,000 ppm by contacting the gaseous contents of said container with the fuel cell and hydrogen under conditions wherein oxygen is converted to water;
d) maintaining the foodstuff in the container such that the oxygen content in the foodstuff and the gaseous environment approaches equilibrium;
e) a second oxygen reduction step wherein the oxygen content in said container is reduced to no more than 2000 ppm; and
f) optionally removing the fuel cell from gaseous communication with the container.

In another aspect, provided herein is a method for producing and maintaining a very low level of oxygen in a sealed container which comprises a foodstuff, said method comprising
a) a first oxygen reduction step wherein the oxygen content in said container is reduced to no more than 5000 ppm;
b) maintaining the foodstuff in the container such that the oxygen content in the foodstuff and the gaseous environment of the container approaches equilibrium; and
c) a second oxygen reduction step wherein the oxygen content in said container is reduced to no more than 1000 ppm.

In another aspect, provided herein is a method for producing and maintaining a very low level of oxygen in a sealed container which comprises a foodstuff, said method comprising
a) replacing oxygen in said container by flushing said container with a low oxygen gas;
b) sealing said container in such a manner that the gaseous contents of said container are in communication with a fuel cell;
c) a first oxygen reduction step wherein the oxygen content in said container is reduced to no more than 5000 ppm by contacting the gaseous contents of said container with the fuel cell and hydrogen under conditions wherein oxygen is converted to water;
d) maintaining the foodstuff in the container such that the oxygen content in the foodstuff and the gaseous environment approaches equilibrium;
e) a second oxygen reduction step wherein the oxygen content in said container is reduced to no more than 1000 ppm; and
f) optionally removing the fuel cell from gaseous communication with the container.

In another aspect, provided herein are containers, systems and devices useful in the methods.

In some embodiments, reduction of oxygen concentration is achieved without reducing of the internal gaseous pressure of the container by more than 50%. In some embodiments, reduction of oxygen concentration is achieved without reducing the internal gaseous pressure by more than 25%. In some embodiments, reduction of oxygen concentration is achieved without reducing the internal gaseous pressure by more than 5%. In some embodiments, reduction of oxygen concentration is achieved without reducing the internal gaseous pressure. This avoids excessive pressure differentiation between inside and outside of the container.

The oxygen reduction steps can employ any method or device for reducing oxygen so long as it is safe for use with foodstuffs. Reduction of oxygen content can be achieved by operation of an oxygen remover, chemical catalytic processes or flushing with a non-oxygen gas, or combination thereof.

In some embodiments, the oxygen content in the atmosphere of the container is reduced by replacing the oxygen with low oxygen gas, preferably non-oxygen gas, such as an inert gas, for example, flushing the container with the inert gas. In some embodiments, the inert gas comprises argon, helium, carbon dioxide, and/or nitrogen. In some embodiments, the inert gas comprises carbon dioxide. In some embodiments, the inert gas is selected from the group consisting of nitrogen, helium and argon. In some embodiments, the inert gas is nitrogen. In some embodiments, the inert gas is a mixture of CO₂ and nitrogen or other inert gas, for example, a mixture of 60% CO₂ and 40% nitrogen. In some embodiments, the low oxygen gas comprises an inert gas and optionally carbon monoxide. Preferably the gas used is acceptable by the relevant regulatory agencies, such as the U.S. Food and Drug Administration (FDA) “GRAS” (Generally Recognized as Safe) food grade carbon dioxide and nitrogen.

It should be understood that one source of oxygen in certain food stuffs is its release from hemoglobin. In such a case, carbon monoxide interacts with and binds more strongly to the hemoglobin than oxygen. Accordingly, for the purposes of this invention, carbon monoxide is considered not to be an inert gas.

Oxygen removers include but are not limited to fuel cells, oxygen absorbers, such as iron containing absorbers, and oxygen adsorbers, that are known in the art and are commercially available. Oxygen removers also include removers utilizing pressure swing adsorption methods (PSA) and membrane separation methods. One or more oxygen removers may be contained internal or external to the container. Different types of oxygen remover may be used together. The oxygen remover is either internal or external to the container. When external to the container, it is in gaseous communication with the container, and optionally can be detached from the container after it ceases operation.

Fuel cells useful herein are known in the art. In some embodiments, the fuel cell is a hydrogen fuel cell. As used herein, a “hydrogen fuel cell” is any device capable of converting oxygen and hydrogen into water. The anode of the fuel cell is in communication with the hydrogen source. This hydrogen source permits generation of protons and electrons. The cathode of the fuel cell is in communication with the environment in the container (the oxygen source). In the presence of oxygen, the protons and electrons generated by the anode interact with the oxygen present at the cathode to generate water.

In one embodiment, the complete fuel cell is external to the container and is in gaseous communication with the container, and optionally can be detached from the container after the fuel cell ceases operation. In some embodiments, the hydrogen source that is in gaseous communication with fuel cell is external to the container.

In one embodiment, the complete fuel cell is internal to the container and the hydrogen source is either internal or external to the container.

The container further optionally comprises a holding element suitable for maintaining a hydrogen source internal or external to the container. The holding element for the hydrogen source in the container preferably is a box or bladder configured to hold the hydrogen source and, in some embodiments, the fuel cell. In some embodiments, the hydrogen source is one or more cylinders comprising compressed hydrogen.

Catalytic systems, such as those utilizing elemental metal such as platinum or palladium catalysts, can be used as oxygen removers but the use of powders necessary to provide high catalytic surface area runs the risk of contamination. Nevertheless, when appropriate safeguards are used, these can be employed. Such safeguards include embedding the metal catalysts into a membrane electrode assembly such as present in PEM fuel cells.

In some embodiments, the air inside the container is pumped to the oxygen remover, such as a fuel cell, by a pump that is in gaseous communication to both the container and the oxygen remover.

The oxygen reduction steps can use the same or different methods. Gas flush and oxygen remover, such as fuel cell, operation can be done independently or in combination. In some embodiments, the container is flushed prior to turning on the oxygen remover, such as fuel cell, in either or both oxygen reduction steps. In some embodiments, the container is flushed while the oxygen remover, such as fuel cell, is in operation to remove oxygen in either or both oxygen reduction steps.

In some embodiments, the container comprises plumbing valves and fittings for use to flush the container with the low oxygen gas, such as an inert gas, to replace the oxygen, and/or for communication with the oxygen remover. For example, the low oxygen gas used to flush the container is introduced from an inlet, the gas in the container that is replaced by the low oxygen gas flush is released through an outlet. After the flush, the inlet and outlet are closed to maintain the atmosphere obtained by the flush.

In some embodiments of the methods, after the first oxygen reduction step, the foodstuff is incubated in the atmosphere with the reduced oxygen content for at least about 1 hour before the second oxygen reduction step. In some embodiments, the foodstuff is incubated in the atmosphere after the first oxygen reduction step for at least 2 hours, 5 hours, 7 hours or at least 12 hours before the second oxygen reduction step.

In some embodiments of the methods, in the first oxygen reduction step, the oxygen concentration in the atmosphere of the container is further reduced to no more than 20,000 ppm, no more than 10,000 ppm, no more than 5000 ppm, no more than 3000 ppm, no more than 1500 ppm, or no more than 1000 ppm.

In some embodiments of the methods, in the second oxygen reduction step, the oxygen concentration in the atmosphere of the container is further reduced to no more than 2000 ppm, no more than 1000 ppm, no more than 500 ppm, no more than 100 ppm, or no more than 10 ppm.

In some embodiments, the container is a tote comprising a flexible, collapsible or expandable material with limited oxygen permeability which does not puncture when collapsing or expanding. The tote can withstand or volumetrically compensate for, the internal pressure loss such as carbon dioxide absorption by the foodstuff, or pressure gain, such as reduction of barometric pressure during transport and/or shipment.

In some embodiments, the tote comprises an initial headspace that compensates for absorption of carbon dioxide by the foodstuff permitting the oxygen concentration in the tote to be maintained at a desired level and/or without creating a vacuum condition. In some embodiments, the initial headspace occupies at least 30 or at least 40 volume percent of the tote. In some embodiments, the initial headspace occupies about 50 volume percent of the tote. In one embodiment, the headspace is about or at least 69 vol. percent of the tote. In some embodiments, the initial headspace is from about 30% to about 95% the internal volume of the tote. In other embodiments, the initial headspace is from about 35% to about 40% of the internal volume of the tote, or alternatively, the initial headspace is about 30% to about 35% of the internal volume of the tote, or alternatively, the initial headspace is about 35% of the internal volume of the tote.

In some embodiments, the vertical architecture of the tote facilitates minimizing horizontal space requirements for shipping the maximum number of pallets side-by-side. Embodiments that spread the headspace out horizontally may not be as economically viable at a large scale in addition to not enjoying the leak resistance as long as the headspace remains positive. In certain embodiments, no more than about 20% of the expansion of the tote is in the horizontal direction, with the remainder of the gaseous expansion being in the vertical direction thus creating the “head pressure” and head space height of the tote. The tote is configured to expand in a vertical manner creating an initial “head pressure” after the first and/or second oxygen reduction steps. Initial tote head pressures can range from about 0.1 to about 1.0 inches of water column or more above atmospheric pressure. The flexible tote can be made more flexible in the vertical direction than in the horizontal by conventional methods, such as using more flexible material in the vertical direction.

In some embodiments, the totes are able to accommodate a sufficient headspace such that the tote would require no continuous oxygen monitoring and/or further oxygen reduction step after the second oxygen reduction step.

In some embodiments, the container is a rigid room or container. When the container is a rigid room or container, after the second oxygen reduction step, an inert gas, such as nitrogen, or carbon dioxide, can be introduced continuously or intermittently as needed to the room or container to compensate for gas absorption by the foodstuff and keep the oxygen concentration at a desired low level until the foodstuff is released for distribution.

Alternatively, an oxygen remover may be operated continuously or intermittently to keep the oxygen concentration at a desired low level.

In some embodiments, the container comprises one or multiple unitized packaging elements described in U.S. patent application Ser. No. 13/,______, entitled “Packages and methods for storing and transporting perishable foods” (Attorney Docket 072801-1350), filed on even date, the content of which is incorporated by reference in its entirety.

In some embodiments of the methods, the foodstuff is red meat. In some embodiments, the foodstuff is beef, lamb or pork. In some embodiments, the foodstuff is fish. In some embodiments, the fish is fresh fish selected from the group consisting of salmon, tilapia, tuna, shrimp, trout, catfish, sea bream, sea bass, striped bass, red drum, pompano, haddock, hake, halibut, cod, and arctic char. Most preferably, the fresh fish to be transported and/or stored is salmon or tilapia. In some embodiments, the foodstuff is tilapia. In some embodiments, the foodstuff is tuna, mackerel and other seafoods.

The methods can be used in the transporting or storing the foodstuff for a time periods in excess of 100 days. In some embodiments of the methods, the transportation and/or storage is for a time period of at least 3 days. In some embodiments, the transportation and/or storage is for a time period of at least 5, 10, 15, 30, or 45 days.

Oxygen may accumulate in the container during transportation and/or storage by, for example, diffusion into the container through the material of limited oxygen permeability or at the seal of the container. In some embodiments, the oxygen concentration of the atmosphere of the container is maintained at or below 1000 ppm during the transportation and/or storage by, for example, operation of the one or more fuel cells or additional flushes with a gas comprising an inert gas. The removal of oxygen can be performed continuous or periodically. If performed periodically, the removal of oxygen can be pre-programmed according to a schedule or triggered by a preset oxygen concentration in the container.

In some embodiments, after the second oxygen reduction step, the oxygen content of the container is maintained at no more than 1000 ppm without further oxygen reduction operation. In some embodiments, the oxygen reduction steps are performed at the starting point of the transportation of the foodstuff. After the oxygen reduction steps, the container is disconnected from the oxygen remover or low-oxygen source used to flush the container.

### Systems

In another aspect, provided herein is a system useful in transporting and/or storing of a foodstuff.

In some embodiments, the system comprises a low oxygen source, such as an inert gas source, for providing the low oxygen gas to replace the oxygen in the container in the oxygen reduction steps. The low oxygen gas source is as described herein. In some embodiments, the inert gas comprises argon, helium, nitrogen, and/or carbon dioxide, such as the inert gases described herein. In some embodiments, the inert gas source can be disconnected from the container after the first or the second oxygen reduction step.

In some embodiments, the container may contain at least one inlet controlled by a valve. The inlet may be connected to a source of low oxygen gas and allows the low oxygen gas to enter into the container to replace at least a portion of the atmosphere of the container that contains oxygen to reduce the oxygen content during the first and/or second oxygen reduction step.

The container may further comprise at least one outlet controlled by a valve which allows the gas inside the container to escape when the low oxygen gas is introduced to the container. In some embodiments, the outlet is connected to one or more oxygen removers, such as fuel cells, and then to one or more of the inlets. In these embodiments, the gas inside the container flushed out by the low oxygen gas is passed through the one or more oxygen removers to remove the oxygen from the gas. The gas with oxygen removed can be an inert gas source and is then reintroduced to the container through the inlet that is connected to the one or more fuel cells.

In some embodiments, the system comprises one or more oxygen removers, such as fuel cells. The containers are in gaseous communication with one or more of fuel cells internal or external to the containers. One fuel cell may be in gaseous communication with one or multiple containers. Multiple containers may share one or more fuel cells external to the containers. In some embodiments, the fuel cells can be disconnected from the container after the first or the second oxygen reduction step.

The system optionally further comprises one or more hydrogen sources for operation of the fuel cells to remove oxygen. In some embodiments, the system further comprises a fan. In some embodiments, the fan is powered by the fuel cell. In some embodiments, the fan is powered by another power source.

In some embodiments, the hydrogen source for the fuel cell is either a bladder hydrogen source, a rigid container hydrogen source, or a gaseous mixture comprising carbon dioxide and less than 5% by volume hydrogen. In another embodiment, the hydrogen source is contained within a rigid container, such as a gas cylinder. In this embodiment, the hydrogen source is a compressed or uncompressed hydrogen source. In some embodiments, the hydrogen source is uncompressed, which, for example, has a pressure of not greater than 40 psia. Compressed hydrogen sources are preferably maintained at a pressure of no greater than 10,000 psia. The hydrogen source is in direct communication with the anode of the hydrogen fuel cell in such a manner as to provide hydrogen for the duration of the transporting or storage time.

In further embodiments, the hydrogen source is generated by a chemical reaction. Examples of methods of chemically generating hydrogen are well known in the art and include generation of hydrogen by an electrolytic process, including methods using PEM electrolyzers, alkaline electrolyzers using sodium or potassium hydroxide, solid oxide electrolyzers, and generation of hydrogen from sodium borohydride. In each case, the hydrogen is generated so that the hydrogen is made available to the anode of the fuel cell.

In another embodiment, the hydrogen source is a gaseous mixture comprising hydrogen present in the environment of the container. In this embodiment, the gaseous mixture preferably comprises carbon dioxide and hydrogen. In other embodiments, the gaseous mixture comprises nitrogen and hydrogen. In further embodiments, the gaseous mixture comprises hydrogen, carbon dioxide, and nitrogen. It is contemplated that other inert gases can be present in the gaseous mixture. In some embodiments, the amount of hydrogen present in the gaseous mixture is less than 10% hydrogen by volume, less than 5% hydrogen by volume, or less than 2% hydrogen by volume.

In some embodiments, the fuel cell comprises a carbon dioxide remover in direct communication with the sealed anode component of the fuel cell. Carbon dioxide has the potential to permeate across the PEM to anode plate, thereby interfering with hydrogen access to the anode plate. Removal of some or all of the carbon dioxide from the anode plate of the fuel cell by the carbon dioxide remover allows increased access to the fuel cell by hydrogen and thus increasing the fuel cells ability to remove oxygen from the container environment.

There are numerous processes known in the art that can be utilized in the carbon dioxide remover. These methods include absorption processes, adsorption processes, such as pressure-swing adsorption (PSA) and thermal swing adsorption (TSA) methods, and membrane-based carbon dioxide removal. Compounds that can be used in the carbon dioxide removers include, but are not limited to, hydrated lime, activated carbon, lithium hydroxide, and metal oxides such as silver oxide, magnesium oxide, and zinc oxide. Carbon dioxide can also be removed from the anode by purging the anode with a gas, such as hydrogen gas or water vapor.

In one embodiment, the carbon dioxide remover comprises hydrated lime. In this embodiment, for example, the hydrated lime is contained in a filter cartridge that is in vapor communication with the fuel cell anode so that the carbon dioxide present at anode plate of the fuel cell comes into contact and with and is absorbed to the hydrated lime. A particular embodiment comprises two hydrated lime filter cartridges, each in vapor communication with an anode outlet. The hydrated lime filters facilitate removal of carbon dioxide from the anode plate of the fuel cell.

The container or the system optionally further comprises a holding element suitable for maintaining the hydrogen source so as the hydrogen source is held stably within the container or the system. The holding element can be either internal or external to the container. In one embodiment, the holding element is a box configured to stably hold the hydrogen source, and optionally the fuel cell. In other embodiments, the holding element is a sleeve affixed to an internal wall of the container. This sleeve is capable of holding a bladder-containing hydrogen source or rigid container hydrogen source as well as other containers suitable for containing a hydrogen source. In either event, the hydrogen source is in direct communication with the anode of the fuel cell.

When the fuel cell and/or the hydrogen source is internal to the container, it is contemplated that it may be desirable to limit the exposure of the foodstuff to excess hydrogen during transportation or storage. Accordingly, in some embodiments, the container or system is configured to minimize the exposure of the foodstuff to hydrogen present in the environment. This can be achieved by removing the excess hydrogen in the container or system by mechanical methods, such as shut off valves or flow restrictors to modulate, chemical methods, or combinations thereof. Examples of chemical methods of removing hydrogen include the use of a hydrogen sink comprised of polymers or other compounds that absorb hydrogen. Compounds suitable for use as hydrogen absorbers are known in the art and are commercially available (“Hydrogen Getters” Sandia National Laboratories, New Mexico; REB Research & Consulting, Ferndale, Mich.) The compounds can be present in the container or can be in direct communication with the cathode of the fuel cell. Flow of hydrogen can be controlled by using an oxygen sensor connected to the hydrogen source such that hydrogen flow is minimized or eliminated when the level of oxygen falls below a minimum set point.

When the fuel cell is internal to the container, water generated by a hydrogen fuel cell may be released into the container, for example, to a water-holding apparatus, such as a tray or tank, configured to collect the water as it is generated by the fuel cell. Alternatively, the container may contain desiccant or absorbent material that is used to absorb and contain the water. Suitable desiccants and absorbent materials are well known in the art. The water may alternatively be vented outside of the container, thus providing a suitable environment for the storage and transportation of goods that are optimally stored in dry environments.

In some embodiments the container further comprises a fan. In some embodiments, the fan is powered by the fuel cell. In some embodiments, the fan is powered by another power source.

In some embodiments, the container is a rigid room or container described herein.

In some embodiments, the container is a tote described herein.

In some embodiments, the system further comprises a pump between the container and the oxygen remover, such as a fuel cell, for pumping the air inside the container to the oxygen remover.

The flexible, collapsible or expandable tote materials for use in this invention are those having limited oxygen permeability. Materials of limited oxygen permeability preferably have an oxygen transmission rate (OTR) of less than 10 cubic centimeters/100 square inch/24 hours/atm, more preferable materials of limited oxygen permeability are materials having an OTR of less than 5 cubic centimeters/100 square inch/24 hours/atm, even more preferably materials of limited oxygen permeability materials having an OTR of less than 2 cubic centimeters/100 square inch/24 hours/atm; most preferably materials of limited oxygen permeability are materials having an OTR of less than 1 cubic centimeters/100 square inch/24 hours/atm. A non-exhaustive list of materials that can be used to make the flexible, collapsible or expandable tote is shown in Table 1.

TABLE 1

| | Moisture Vapor | Oxygen |
|---|---|---|
| | Transmission | Transmission |
| | Rate (MVTR) | Rate OTR |
| | (gm/100 sq. | (c.c./100 sq. |
| MATERIAL | in./24 hours) | in./24 hours/atm) |
| Saran 1 mil | 0.2 | 0.8-1.1 |
| Saran HB 1 mil | 0.05 | 0.08 |
| Saranex 142 mil | 0.2 | 0.5 |
| Aclar 33C .75 mil (military | 0.035 | 7 |
| grade) | | |
| Barex 210 1 mil | 4.5 | 0.7 |
| Polyester 48 Ga. | 2.8 | 9 |
| 50 M-30 Polyester Film | 2.8 | 9 |
| 50 M-30 PVDC Coated Polyester | 0.4 | 0.5 |
| Metallized Polyester 48 Ga. | 0.05 | 0.08-0.14 |
| Nylon 1 mil | 19-20 | 2.6 |
| Metallized Nylon 48 Ga. | 0.2 | 0.05 |
| PVDC-Nylon 1 mil | 0.2 | 0.5 |
| 250K Cello | 0.5 | 0.5 |
| 195 MSBO Cello | 45-65 | 1-2 |
| LDPE 2 mil | 0.6 | 275 |
| Opp .9 mil | 0.45 | 80 |
| EVAL, Biax 60 Ga. | 2.6 | 0.03 |
| EVAL EF-E 1 mil | 1.4 | 0.21 |
| EVAL EF-F 1 mil | 3.8 | 0.025 |
| Benyl H 60 Ga | 0.7 | 0.4 |
| PVC 1 mil | 4-5 | 8-20 |
| Polycarbonate 1 mil | 9 | 160 |
| Polystyrene 1 mil | 7.2 | 4,800 |
| Pliofilm 1 mil | 1.7 | 660 |

The container and/or the system may further comprise a temperature control system, such as cooling system, for maintaining a temperature of the container sufficient to preserve the color of the pigment and freshness of the foodstuff. Such temperatures would depend on the nature of the pigment and/or the foodstuff, and can be determined by one of skill in the art. The temperature is generally maintained in a range of about 32-38° F., a range of 32-35° F., or a range of 32-33° F. or 28-32° F. Variation in the temperature is allowed as long as the temperature is maintained within a range to preserve the foodstuff.

The container optionally contains monitors to monitor and/or record oxygen levels, hydrogen levels, fuel cell operation, and/or temperature, etc. In a particular embodiment, an oxygen sensor, for example, a trace oxygen sensor (Teledyne), is used to monitor the level of oxygen present in the container environment. The oxygen monitor may trigger operation of the oxygen remover and/or provide an alert when the oxygen level in the container exceeds a predetermined level. Optionally, the container further comprises a box comprising one or more of these monitors. The box further optionally comprises a visible indicator, such as an LED light, which indicates problems of the devices in the box so that the problematic device or the box can be immediately replaced before sealing the container. This facilitates rapid detection of any failure by unskilled labor and allows for rapid turn-around of boxes into service with minimal testing. The box also alerts users on arrival of system if oxygen or temperature (time and temperature) limits are exceeded, for example, using wireless communication, such as radio frequency transmission, along with a visible indicator, such as a red LED light.

In some embodiments, the system is a unitized packaging system and the container comprises one or multiple unitized packaging elements described in U.S. patent application Ser. No. 13/,______, entitled “Packages and methods for storing and transporting perishable foods” (Attorney Docket 072801-1350), filed on even date, the content of which is incorporated by reference in its entirety.

The system or containers are configured so as to be suitable for transporting and/or storing in a shipping freighter. A shipping freighter means any vehicle that can be used to transport and/or store the system including, but not limited to, an ocean shipping freighter, a trucking shipping freighter (such as a tractor-trailer), a railroad car, and an airplane capable of transporting cargo load. One or more containers can be used in a single shipping freighter and each can be configured to have a different gaseous environment as well as a different foodstuff. The containers can be delivered to the same or different site(s). The size of each container can be different. The containers may hold as little as a few ounces of foodstuff to as much as, or greater than, 50,000 pounds, or tons of foodstuff. In some embodiments, the container can hold about 500 pounds, about 1000 pounds, or about 2000 pounds of foodstuff. The number of packaging modules per system depends both on the size of the shipping freighter used to transport and/or store the foodstuff and the size of the containers.

What is claimed is:

1. A method for producing and maintaining a very low level of oxygen in a sealed container which comprises a foodstuff, said method comprising
a) a first oxygen reduction step wherein the oxygen content in said container is reduced to no more than 20,000 ppm;
b) maintaining the foodstuff in the container such that the oxygen content in the foodstuff and the gaseous environment of the container approaches equilibrium; and
c) a second oxygen reduction step wherein the oxygen content in said container is reduced to no more than 2000 ppm.

2. The method of claim 1, wherein the oxygen content after the second oxygen reduction step is maintained in the sealed container for at least three days.

3. The method of claim 1, wherein the oxygen concentration is reduced in each step by a fuel cell, flush with a low-oxygen gas, or combination thereof.

4. The method of claim 3, wherein the fuel cell is internal to the container.

5. The method of claim 3, wherein the fuel cell is external to the container.

6. The method of claim 3, wherein the low oxygen gas is an inert gas.

7. The method of claim 6, wherein the inert gas is nitrogen, carbon dioxide, a combination thereof.

8. The method of claim 1, wherein the oxygen concentration in the atmosphere of the sealed container is reduced to no more than 5000 ppm after the first oxygen reduction step.

9. The method of claim 1, wherein the oxygen concentration in the atmosphere of the sealed container is reduced to no more than 3000 ppm after the first oxygen reduction step.

10. The method of claim 1, wherein the foodstuff is incubated in the atmosphere produced after the first oxygen reduction step for at least 1 hour.

11. The method of claim 1, wherein the foodstuff is incubated in the atmosphere produced in the first oxygen reduction step for at least 6 hours.

12. The method of claim 1, wherein the oxygen concentration in the atmosphere of the sealed container is reduced to no more than 1000 ppm after the second oxygen reduction step.

13. The method of claim 1, wherein the oxygen concentration in the atmosphere of the sealed container is reduced to no more than 100 ppm after the second oxygen reduction step.

14. The method of claim 1, wherein the sealed container is a tote comprising a flexible, collapsible or expandable material.

15. The method of claim 14, wherein the tote comprises a headspace.

16. The method of claim 1, wherein the sealed container is rigid container.

17. The method of claim 1, wherein the foodstuff is meat or fish.

18. A method for producing and maintaining a very low level of oxygen in a sealed container which comprises a foodstuff, said method comprising
a) replacing oxygen in said container by flushing said container with a low oxygen gas;
b) sealing said container in such a manner that the gaseous contents of said container are in communication with a fuel cell;
c) a first oxygen reduction step wherein the oxygen content in said container is reduced to no more than 20,000 ppm by contacting the gaseous contents of said container with the fuel cell and hydrogen under conditions wherein oxygen is converted to water;
d) maintaining the foodstuff in the container such that the oxygen content in the foodstuff and the gaseous environment approaches equilibrium;
e) a second oxygen reduction step wherein the oxygen content in said container is reduced to no more than 2000 ppm; and
f) optionally removing the fuel cell from gaseous communication with the container.

19. The method of claim 18, wherein the oxygen content after the second oxygen reduction step is maintained in the sealed container for at least three days.

20. The method of claim 18, wherein the oxygen concentration is reduced in each step by a fuel cell, flush with a low-oxygen gas, or combination thereof.

21. The method of claim 20, wherein the fuel cell is internal to the container.

22. The method of claim 20, wherein the fuel cell is external to the container.

23. The method of claim 20, wherein the low oxygen gas is an inert gas.

24. The method of claim 23, wherein the inert gas is nitrogen, carbon dioxide, a combination thereof.

25. The method of claim 18, wherein the oxygen concentration in the atmosphere of the sealed container is reduced to no more than 5000 ppm after the first oxygen reduction step.

26. The method of claim 18, wherein the oxygen concentration in the atmosphere of the sealed container is reduced to no more than 3000 ppm after the first oxygen reduction step.

27. The method of claim 18, wherein the foodstuff is incubated in the atmosphere produced after the first oxygen reduction step for at least 1 hour.

28. The method of claim 18, wherein the foodstuff is incubated in the atmosphere produced in the first oxygen reduction step for at least 6 hours.

29. The method of claim 18, the oxygen concentration in the atmosphere of the sealed container is reduced to no more than 1000 ppm after the second oxygen reduction step.

30. The method of claim 18, the oxygen concentration in the atmosphere of the sealed container is reduced to no more than 100 ppm after the second oxygen reduction step.

31. The method of claim 18, wherein the sealed container is a tote comprising a flexible, collapsible or expandable material.

32. The method of claim 31, wherein the tote comprises a headspace.

33. The method of claim 18, wherein the sealed container is rigid container.

34. The method of claim 18, wherein the foodstuff is meat or fish.
